(19) United States
(12) Patent Application Publication
(10) Pub. No.: US 2006/0200379 A1
(43) Pub. Date: Sep. 7, 2006

(54) Road toll collection system

(76) Inventor: Werner Biet, (US)

Correspondence Address: CROWELL & MORING LLP;INTELLECTUAL PROPERTY GROUP, P.O. BOX 14300, WASHINGTON, DC, 20044-4300, US

(21) Appl. No.: 11/045,068

(22) Filed: Jan. 31, 2005

Related U.S. Application Data
(63) Continuation of application No. 10/861,425, filed on Jun. 7, 2004, now abandoned.

(30) Foreign Application Priority Data
Jan. 31, 2001 (DE) 101 04 499.2

(51) Int. Cl. G07B 15/00

(52) U.S. Cl. 705/13

(57) ABSTRACT

A road toll collection system includes a vehicle device for the vehicle-autonomous determination of a road toll for a vehicle within a use billing area. Data required for determining the road toll are transmitted, when required, from an operator control center to the vehicle device by means of a communications device, and the vehicle device determines partial tolls which are incurred continuously for traveled route sections, as well as the total toll for a journey by summing the individual part tolls. When predefined criteria are fulfilled, the vehicle device transmits the currently determined total toll via the communications device to an operator control center for billing.

This application claims the priority of German patent document 101 04 499.2, filed 31 January 2001 (PCT Application No. PCT/EP01/14678, filed 13 December 2001), the disclosure of which is expressly incorporated by reference herein.

### BACKGROUND AND SUMMARY OF THE INVENTION

The present invention relates to a road toll collection system.

German patent document DE 44 02 613 A1 describes a road toll collection system of the generic type having a vehicle device for determining a road toll autonomously with respect to a vehicle. Where necessary, data which is required to determine the road toll is transmitted from an operator control center to the vehicle device. The vehicle device determines part tolls for sections of routes which are traveled. If the total toll, which is determined by summing the individual part tolls, reaches a predefined level, the total toll is transferred to an operator control center.

German patent document DE 43 04 838 C2 describes a road toll collection system having a vehicle device for the vehicle-autonomous determination of a road toll. Data required for determining the road toll transmitted, when necessary, from an operator control center to the vehicle device by means of a communications device. The vehicle device determines part tolls which are incurred continuously for route sections traveled on and determining the total toll for a journey by summing the individual part tolls.

One object of the present invention is to provide an improved road toll collection system of the type described above, in which convenience for the operator is increased.

This and other objects and advantages are achieved by the toll collection system according to the invention, in which the toll is determined by means of a vehicle borne device while the actual billing is carried out in an operator control center. The transmission of incurred tolls to the operator control center depends on criteria which can be predefined. This arrangement has an advantage over systems in which the billing is carried out in the vehicle by means of chip cards, in that the user does not need to be concerned with having a sufficient amount of credit on his chip card. Furthermore, with chip cards there is the risk of loss.

A further advantage is that with the system according to the invention the toll can be determined relatively simply for different use billing areas with a single vehicle device.

In one advantageous refinement of the invention, the predefined criteria are fulfilled if a threshold value (for example, a specific amount of money, a specific time period and a certain distance covered since the last time when data were transmitted) is reached or exceeded. This has the advantage that the amount of toll which is stored in the vehicles does not become too high. Of course, the criteria can also be fulfilled if the data is requested by the operator control center or if the transmission of data is triggered manually by the user. In addition, the transmission of data can be triggered when the vehicle travels through predefined positions in the route network. Thus, a transmission of data can be triggered whenever a road for which a toll is due is left, for example.

In one particularly advantageous refinement of the invention, the user of the vehicle or holder of the vehicle keeps an account with the operator of the road toll collection system, from which account the transmitted tolls are automatically deducted.

In another advantageous embodiment of the invention, in order to determine the road toll for a vehicle when different use billing areas are traversed, information about the boundaries of at least one home use area is stored and, when the boundary of the home use area is approached, missing operating data for an adjoining use billing area are transmitted, when required, from the operator control center into the vehicle device and stored.

The vehicle device calculates the road toll according to the conditions of the new use billing area. The tolls which are determined are transmitted to the operator control center of the new use billing area. However, these tolls are billed only if the operator of the home use billing system confirms transfer of the responsibility of the holder of the vehicle.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic view of an automatic toll collection system and its external data relationships;

FIG. 2 is a schematic view of an automatic toll collection system and its internal data relationships;

FIG. 3 illustrates the essential functions and components of the vehicle device;

FIG. 4 illustrates the operating sequence of the vehicle device;

FIG. 5 shows an example of different use billing areas.

In the following description, “toll” means fees which are to be paid to use a road. “Toll levying system” or “toll collection system” means a system for collecting fees for using roads.

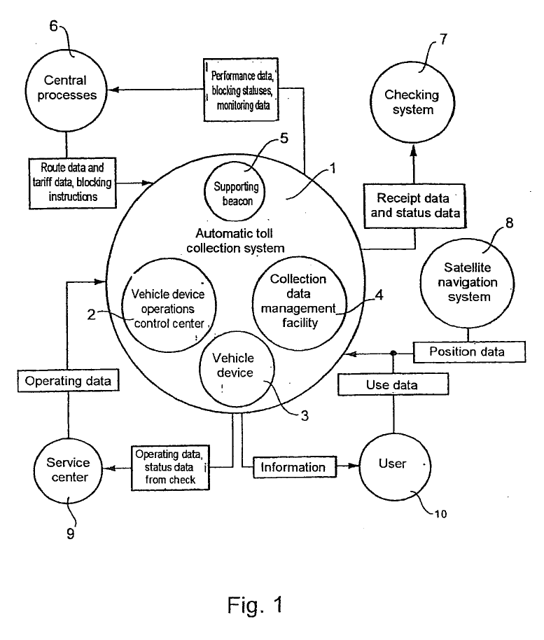

As shown in FIG. 1, an automatic toll collection system 1 comprises a vehicle device operations control center 2, corresponding vehicle devices 3, collection data management facility 4 and supporting beacons 5. The main components of the system 1 include the vehicle device 3, which fulfills autonomously on board the vehicle all the functions, such as detection of route sections for which a toll is due, calculation of the toll and transmission of the collection data, which are necessary for levying a toll. Vehicles of participants in the automatic toll collection system 1 are equipped with vehicle devices 3 at authorized service centers 9. When it is installed, the device 3 is provided with valid operating data (road model with detection points and tariff model) and with the data of the vehicle. When necessary, this data is updated—preferably by means of mobile radio (GSM). Using this data, the vehicle device 3 detects autonomously whether it is located on a route section for which a toll is due, and on which route section for which a toll is due it is located. It calculates the tolls on the basis of the vehicle parameters, the tariff parameters and the kilometers traveled on routes for which tolls are due, and brings about the payment. This data is transmitted to the operator control center 2 for further processing by means of mobile radio (GSM). In order to support the establishment of facts, the vehicle device 3 communicates with the control system 7 by means of short-range communication (DSRC). The locating process is carried out by the vehicle device 3 by means of a satellite navigation system (GPS) 8. In a small number of cases it is necessary for the vehicle device 3 to be supported during the determination of locations by additionally installed supporting beacons 5.

The method of operation for the individual components is as described below.

The vehicle device operations control center 2 supplies the vehicle devices 3 with the necessary operating data and passes on to them messages from the “central processes” component. It converts the operating data into a format which can be processed by the vehicle device 3. In the process it controls the distribution of the operating data to the vehicle devices 3. From the vehicle device 3, it receives status information about blocks and passes it on to the “central processes” component 6.

The toll collection management facility 4 receives the toll collection data generated by the vehicle device 3, stores it and passes it on in the form of performance data to the “central processes” component 6. The collection data management facility 4 generates acknowledgements for plausible received collection data and distributes them, the respective credit framework and the limits to the vehicle devices 6.

When routes for which a toll is due are used by vehicles for which a toll is due or vehicle-trailer combinations, the vehicle device 3 automatically carries out collecting processes and passes on the collection data to the collection data management facility 4. In order to make it functionally ready, it receives operating data from the vehicle device operations control center 2. Furthermore, it provides the user 10 with an operator interface 5 via which he can input his use data and call up information.

The service center 9 performs installation, repairs and cyclical checking of the vehicle device 3.

The user 10 is the person liable to pay tolls who uses the toll system to pay fees and operates the vehicle device 3.

The checking system 7 determines and confirms whether there is a duty to pay a toll, and if so, whether the toll has been paid correctly, incorrectly or not at all.

The central processes 6 include the methods and processes of the organizational units comprising business management, technical support, servicing, accounts, resources, sales and marketing and personnel functions. These are supported by the billing, monitoring and operations execution system components.

The billing component has the primary function of periodically aggregating the payment data (collection and funds receipt data) of the automatic toll collection system 1, creating invoices from it, distributing them to the people 10 liable to pay tolls and generating confirmation of the invoices issued.

The monitoring component comprises all the technical devices for mapping the methods and processes which make it possible to check whether the toll system and the operator company correctly fulfill their functions.

The operations execution component comprises all the technical devices which are used for operations control by the operator company, accounting, customer care and technical support.

The supporting beacon 5 supports the vehicle device 6 in the determination of positions by transmitting high-quality position data via short-range communication.

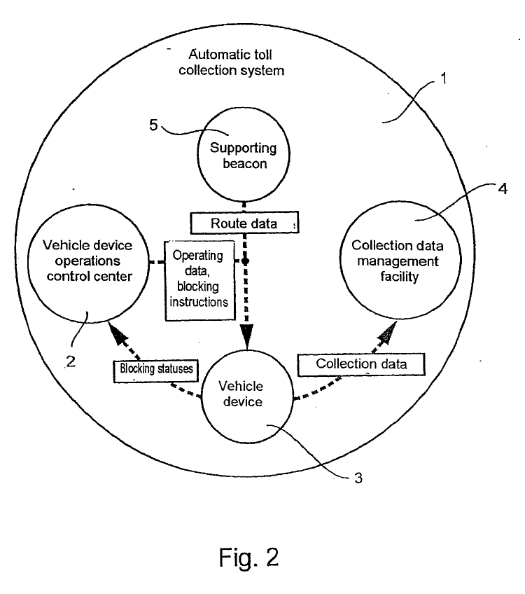

FIG. 2 shows the internal data relationships in the automatic toll collection system 1.

The vehicle device operations control center 2 of the toll system 1 supplies all the vehicle devices 3 with the necessary and current operating data via a communications server. The functions of the vehicle device operations control center 2 include:
the supply of all the vehicle devices 3 with operating data such as route data, tariff models, toll class models, vehicle device software versions and cryptography keys;
the decryption or encryption and signing of vehicle device messages;
the certification of public keys of the approval centers/service centers;
the provision of the operating data for all service centers 9 and the checking control center 7;
the management of the operating data versions;
the creation of operating data distribution plans;
the conversion of the operating data into the vehicle device format;
the simulation test of the operating data.

A replication mechanism ensures that a current version of the basic database is always available as a copy in the vehicle device operations control center 2. The cryptography component encrypts and decrypts the received data and the data to be transmitted, ensures the integrity of the messages and manages all the communications keys required in the vehicle device operations control center 2. Data distribution plans are also produced in the vehicle device operations control center 2. So that the vehicle devices 3 can operate autonomously, not only the necessary communications keys but also the operating data (tariffs, routes, vehicle classes) are stored in them. The operating data is updated in the basic data management facility and managed, in a conditioned form (vehicle device format), in the database of the vehicle device operations control center 2. The vehicle device software versions are also located there. The process of the “transfer of operating data” has the purpose of supplying the vehicle devices 3 with new or updated operating data in a way which is dependent on versions and provides area coverage. Both broadcast services and point-to-point connections of GSM communication are used for this. All the vehicle devices 3 which are not reached via broadcast sign on, before the validity of their operating data expires, at the vehicle device operations control center 2 to which these requests for decryption and processing are passed on. It then supplies the vehicle devices 3 individually with the current tariff and route data.

The vehicle device operations control center 2 not only transmits operating data to the vehicle devices 3 but also makes available information for the service centers 9 which install and maintain vehicle devices 3. The checking control center 7 also has access to the current data of the vehicle device operations control center 2.

The functions of the collection data management facility 4 are:
management and processing of the collection data transmitted by the vehicle devices 3,
generation of acknowledgements for the collection data received from the vehicle devices 3,
compilation of, in each case, a list of blocked vehicle devices 3 and a list of all the credit limits,
authentication of the incoming and outgoing messages,
encryption and decryption of the requests from and the responses to the vehicle devices 3,
transmission of the accumulated collection data records to the billing system.

An essential function of the collection data management facility 4 is the acknowledgement or answering of all vehicle device messages and the updating of all the data necessary for processing these messages. To do this, the messages which are transmitted by the vehicle devices 3 via GSM and received by a communications server and which contain collection data are, if necessary, collected, decrypted and stored in the collection database. For the messages, acknowledgements are generated which additionally contain the respectively current blocked state of the collection card and its limits and, if appropriate, contain new keys from the security control center. These acknowledgements are encrypted and transmitted to the vehicle devices 3. If a vehicle device 3 has received no acknowledgement from the central system after a certain time has passed, the central system transmits the respective data once more to the collection data management facility 4 until the acknowledgement is received from the vehicle device 3.

Supporting beacons 5 are set up on the roadside at such locations at which it is difficult, or not sufficiently reliable, to determine positions of the vehicle devices 3 solely by means of satellite navigation 8 and compound navigation. These may be, for example, ravines with steep rock walls on one or both sides of the road, tunnels, heavily wooded areas or roads which are close to one another (i.e. a few meters from one another) and are of different, or even the same, road category, as well as roads with a temporary change to the path they follow. The supporting beacon 5 transmits the respective position data to the vehicle devices 3 and in so doing supports the vehicle device 3.

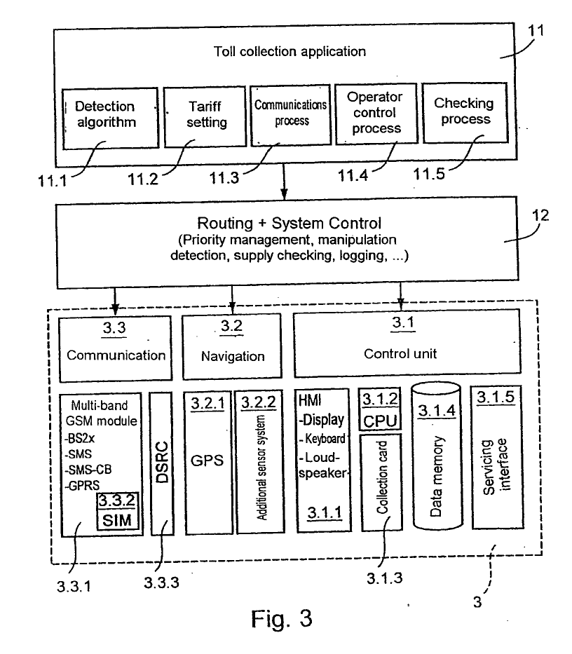

FIG. 3 is an overview of the software components and hardware components of the vehicle device 3. The toll collection application 11 includes a detection algorithm 11.1, tariff setting 11.2, a communications process 11.3, an operator control process 11.4 and a checking process 11.5.

The detection algorithm 11.1 detects a route section which is subject to tolls, using route data and the current position, and triggers a collection event.

Tariff setting 11.2 comprises calculating the toll by reference to the route information, the relevant parameters and the data of the tariff model.

The communications process 11.3 comprises the exchange of data between the vehicle device 3 and control center 2 via GSM (transmission of collection data and operating data updates (tariff data/model, route data, software updates)). Furthermore, the communications process 11.3 also includes the exchange of data with the supporting beacon 5 and the checking system 7 via a DSRC interface, and the exchange of data via the servicing interface for servicing purposes.

The operator control process 11.4 is the event-based control of the interaction of the vehicle device 3 with the user 10 (inputs and outputs, warning messages and fault messages, menu control).

The checking process 11.5 comprises the monitoring of the operational capability, power management, logging, trouble ticketing and detection of manipulation.

The operating system 12 constitutes the lowest software level and is developed and made available by the manufacturer of the vehicle device. The operating system performs hardware actuation, priority/process management, detection of manipulation, version checking and logging (at the operating system level).

The automatic toll collection system 1 requires the following hardware components for the vehicle device 3:

Control unit 3.1: control unit with its own operating and file system;
CPU 3.1.2: central processor;
Data memory 3.1.4: volatile and nonvolatile main memory;
Collection card 3.1.3: chip card with security module for managing the cryptographic keys and with payment module for the secured payment of the tolls;
HMI 3.1.1: user interface (keyboard, display and loudspeaker);
Servicing interface 3.1.5: external interface for exchanging data;

Navigation components 3.2:
GPS 3.2.1: module for determining location
Additional sensor system 3.2.2: for improving the navigation data;

Communications components 3.3:
GSM module 3.3.1: module for communicating with central components with SIM card 3.3.2;
DSRC module 3.3.3: module for supporting beacon communication and checking communication by means of infrared;

Power unit (not illustrated): power supply from the vehicle's on-board power system.

In addition to the aforesaid hardware components, further accessories, for example antennas (for GSM, GPS, DSRC modules), cabling sets for antennas, adapters, vehicle device holders, attachment material, are required when the vehicle device 3 is installed.

Central and vehicle-mounted components are required for the automatic toll collection system 1. The control center 2 can be split spatially between a plurality of locations, that is to say can be structured “decentrally”.

Structural and technical devices for checking are necessary to impose the obligation to pay a toll. In exceptional cases, supporting beacons 5 are used as system-supporting infrastructure and mounted on the sides of roads. These beacons are used to support the autonomous determination of position (poor satellite locating, difficult path of road, possibly roadworks). Supporting beacons 5 are generally embodied as infrared transmitters mounted on simple masts.

Furthermore, no new infrastructure whatsoever is necessary as the automatic toll collection system 1 uses existing systems—such as the mobile radio system GSM 3.3.1 or the satellite navigation system GPS 8. Other systems, for example service centers 9, must be adapted in accordance with the requirements of the toll system 1 or modified and some operational sequences have to be restructured.

The individual vehicle requires only one vehicle device 3 including accessories to participate in the automatic toll collection system 1. The installing service center 9 requires a so-called service center PC which permits the vehicle device 3 to be initialized and personalized as well as tested. In addition, this device can be used to transfer necessary status data and operating data from the control center 2.

The automatic toll collection system 1 is connected to other component systems via external interfaces, the interface between the “central processes” component and vehicle device operations control center 2 being implemented as a TCP/IP link by means of LAN or WAN. The interface between the “central processes” component with the collection data management facility 4 is also implemented as a TCP/IP link by means of LAN or WAN. The interface between the checking system 7 and the vehicle device 3 is implemented as a DSRC interface 3.3.3.

The interface between the satellite navigation system 8 and the vehicle device 3 is embodied as a radio interface 3.2.1 (GPS standard).

The vehicle device 3 is equipped with a servicing interface 3.1.5 for communication with the service center 9.

The interface between the supporting beacon 5 and the “central processes” component is embodied as a mobile radio link or fixed network link.

The internal interface in the automatic toll collection system 1 between the vehicle device operations control center 2 and the vehicle device 3 as well as the interface between the vehicle device and the collection data management facility 4 is embodied as a mobile radio link 3.3.1. The interface between the vehicle device 3 and the supporting beacon 5 is embodied as a DRSC interface 3.3.3.

The following main functions take place within the framework of the automatic toll collection system 1:
detection,
collection,
transfer of data,
provision of access to the automatic toll collection system,
support of the checking processes,
ensuring of correct toll collection by the automatic toll collection system 1 itself and the monitoring facility.

During the automatic collection of tolls, the fact that the vehicle is traveling through a route section for which a toll is due is detected autonomously on board the vehicle, i.e., without roadside infrastructure. For this purpose, the vehicle must be equipped with a vehicle device 3 which determines the current position of the vehicle by means of the satellite navigation system GPS 3.2.1 (and possibly a further sensor system 3.2.2). In exceptional cases, supporting beacons 5 for supporting the determination of positions are additionally used on certain route sections if the determination of positions on the basis of GPS and compound navigation is not sufficiently reliable. The detection algorithm for determining a route section for which a toll is due is based on the constant determination of the position of the vehicle device 3.

The collection is carried out on the basis of a detected route section for which a toll is due. The collection-related data (routes for which a toll is due with length and tariffs) is available in the vehicle device 3 for the purpose of classification in the toll classes or are to be input by the user 10 within the framework of a self-declaration process (toll-related parameters for the purpose of the classification in the toll classes). The self-declared parameters are used together with the parameters which are stored permanently in the vehicle device 3, using the tariff model for the purpose of classification in the toll classes. At the time when a route section for which a toll is due is traversed, collection is triggered taking into account the current toll class, the current tariff model and the time. The collection data is collected for further processing and transmitted to the collection data management facility 4. The user 10 is informed about the collection event via visual—optionally also audible—means at the time of collection.

The vehicle device 3 has components for long-range and short-range communication by means of mobile radio and DSRC. The following data are exchanged by mobile radio:

TABLE 1
Long-range communication/types of data to be transmitted

| Type of data | Description |
|---|---|
| Collection data | Transmission of all relevant collection data |
| | together with identification of the vehicle device 3, |
| | by means of which identification the control center |
| | 2 can track each individual collection for a section, |
| | assign it to an account and generate an individual |
| | collection record. The transmission of collection |
| | data is triggered either after a dispatch limit is |
| | exceeded or after a certain time period has |
| | expired. The dispatch limit is a credit |
| | balance/credit facility value. The time period can |
| | be parameterized. It starts with the first collection |
| | since the last dispatch of collection data. If the |
| | dispatch limit has not yet been reached after this |
| | time period expires, the transmission of existing |
| | collection data is nevertheless triggered. At |
| | present a time period of 24 hours is provided. |
| Credit | As the payment-related accounts are located in |
| facility/credit | the control center 2, the vehicle device 3 must be |
| balance | informed of the amount to which the tolls can be |
| reconciliation | totaled. |
| Updating of route | Relevant, updated route data for identification of |
| data | collection points is transmitted into the vehicle |
| | device 3. This ensures that no vehicle device 3 |
| | which is operating carries out incorrect or |
| | excessive collections, or fails to carry out |
| | collections, owing to data which is not up to date |
| | or data which is not present. |
| Updating of tariff | Tariff and toll parameters which will come into |
| and toll class | force in future are transmitted into the vehicle |
| models | device 3. It is ensured that no vehicle device 3 |
| | which is operating carries out incorrect collections |
| | owing to incorrect tariff data or tariff data which |
| | is not up to date. |
| Blocking messages | Transmission of blocking information to the |
| | control center 2 or to the vehicle device 3 |
| | depending on the component at which the blocking |
| | event first occurs. |
| | (Blocking event in the vehicle device 3: the credit |
| | facility or credit balance is exhausted. Blocking |
| | event in the control center 2: the user 10 is no |
| | longer creditworthy, the credit balance account |
| | has been overdrawn, manipulation is suspected or |
| | the vehicle/vehicle device 3 has been stolen.) |
| Warning messages | Transmission of a warning message 4 to the |
| | vehicle device 3 if the remaining credit facility or |
| | the remaining credit in the control center 2 falls |
| | below a critical value. The warning message is |
| | issued in such good time that users 10 or |
| | forwarding agents have sufficient time either to |
| | top up the credit balance account or perform a |
| | funds receipt process, that is to say can at least |
| | cover the route for which a toll is liable, up to the |
| | next payment point. |

Data transmission and protocol securing methods ensure that the same protocol versions are used on both sides of the communication. As a result, data which is to be transmitted can be received free of faults by the opposite side or when the other party cannot be reached the transmission can be repeated at a later time.

In order to protect the data, it is encrypted additionally, above and beyond the standardized encryption in the GSM mobile radio network, by means of a separate cryptographic method at the application level.

The short-range communication is carried out according to the DSRC standard in the infrared range, otherwise by radio in the 5.8 GHz microwave range. Via this interface, data is exchanged with the checking system 7 and data is received from supporting beacons 5 for better determination of positions. The interface is configured in such a way that bidirectional communication can be initiated with the vehicles in the traffic which are liable to pay tolls.

The vehicle device 3 communicates using DSRC with the checking devices of the automatic, mobile and stationary checking facilities. During this communication, the initiative comes from the checking devices. The vehicle device 3 responds to a corresponding inquiry of such a checking device.

During the interaction with the checking system, the following data is exchanged:

TABLE 2
Short-range communication/checking communication

| Type of data | Description |
|---|---|
| Checking | Permanent transmission of identification and |
| broadcast | status data of the checking beacon to vehicle |
| | devices which drive into the transmission range, |
| | in order to trigger the checking process. |
| Receipts | Transmission of all necessary data for an |
| | unambiguous record of payment for the current |
| | section. The data contents prevent repeated use of |
| | a receipt. The transmission of identification and |
| | classification data makes it possible to check a |
| | comparison with the measurement data of the |
| | vehicle supplied by the checking technology. |
| Log files | Transmission of status information and history |
| | information about the state of the vehicle device |
| | and preceding events, for example attempts at |
| | manipulation. |
| History data | Transmission of all relevant data which, in the |
| | case of non-collections or incorrect collections as |
| | well as of incomplete collections, can provide |
| | information on the causes of possible faults or on |
| | manipulations to the vehicle device. (Only in the |
| | case of manual checking) |

For persons 10 who are liable to pay tolls, there are the following access possibilities to the automatic toll collection system:
signing on and registration with an operator company;
searching for a service center 9 (garage) for installation and maintenance of the vehicle device 3;
operation of the vehicle device 3;
the customer service is taken into account by telephone, fax or Internet in order to respond to inquiries and to eliminate unclear points;
processing of payment.

The actual collection of tolls during the journey takes place without interaction with the user.

The automatic toll collection system collects tolls only in the legally specified cases. The correct collection of tolls is ensured by organizational and technical measures. Organizational measures are:
the registration of the user;
the obligation of the user to cooperate;
checking;
monitoring;

Participation in the automatic toll collection system 1 requires the person 10 who is liable to pay tolls to have previously registered himself with the operator company. Here, he specifies individual data and indicates his preferred method of payment. On the basis of this information, the creditworthiness of the user 10 is checked, a contractual relationship between the user 10 and operator company is established and the installation of one or more vehicle devices 3 is brought about.

In vehicles which are only liable for a toll in specific operating states or in which various toll classes are possible for reasons of design, the operating mode must be set by the driver within the scope of self-declaration.

When the vehicle device 3 is installed, the service center 9 sets a “default” class which generally corresponds to the class of the vehicle without a trailer. In the simplest case, this setting only has to be confirmed by the driver 10. In the case of vehicles with fewer than 12 t permitted overall weight in which there is no liability to pay a toll, the class “not liable to pay a toll” is normally set as a “fault”. By means of the operator interface of the vehicle device 3 it is also possible to define that in each case the class declared last is offered as the setting to be confirmed. This deviation from the standard occurs only at the explicit wish of the person 10 who is liable to pay a toll and he must indicate this and in the installation confirmation. The variable setting possibilities of the declaration prevent a vehicle which is not liable to pay a toll, for example a tractive unit without a trailer below 12 t, having to pay tolls in the automatic collection method. During the installation, the other vehicle-specific parameters, for example the pollutants class, are also entered.

The result of the declaration or the fact of nondeclaration (there is no input) is stored with the time and the geographic position in the logbook of the terminal 3 in a way which is protected against voltage failure and against manipulation. This information can be read out for the purpose of checking and used as supplementary evidence.

If, at the start of a journey or when route sections which are liable for tolls are first driven onto, there is no declaration or a false declaration, the driver runs the risk of being detected as a nonpayer or incorrect payer when checking is carried out. Possible incorrect operation or nonoperation can be detected by means of displays on the vehicle device 3 for the person 10 who is liable to pay a toll. The toll class which is set is indicated. The input can also be additionally supported by means of an acoustic signal which is dependent on the declared class. The person 10 who is liable to pay a toll can reduce the risk of nondeclaration or incorrect declaration through the decision on a specific presetting when the vehicle device 3 is installed.

Technical measures for the correct collection of tolls are:
secure and checked collection and communication methods in the vehicle device 3;
unambiguous, all-encompassing calculation rules for the level of toll (tariff model) in the entire toll system with rules for particular handling of individual users 10 and route sections;
the determination of positions is supported by means of supporting beacons 5 at geographically unfavorable points.

The autonomous detection method reliably detects if the vehicle is located outside the route network which is subject to tolls. In this case, the vehicle device 5 does not collect tolls either. In some cases, there are possibilities of turning round between these points, for example at service stations freeway churches carparks, and other facilities or operations which are associated with the freeway. Each existing possibility of turning round defines a detection section or detection subsection.

When the vehicle is parked and when there are interruptions in a journey, the states of the vehicle device 3 are stored—protected against voltage failure and manipulation. As a result, no information can be lost. If the journey is continued, the new information on the start of the journey and declaration of the toll class is requested and stored. Otherwise, the vehicle device 3 operates on the basis of the default values which are set. In particular, the detection method ensures that there is no double collection when a journey is interrupted on a section of freeway. The detection method also prevents multiple collections of a toll when journeys are interrupted within a section of freeway or there are changed lane markings in the region of roadworks.

When the vehicle device 3 is installed and first put into operation, the official motor vehicle registration number is input into its security module of the collection card 3.1.3. The vehicle card which is issued by the operator company serves as a source for this information. This data must be confirmed by submitting the logbook. The motor vehicle registration number is transmitted together with the information on the vehicle device 3 and the installation which has taken place to the vehicle device operations control center 2 on a secured path and stored there. The vehicle card, collection card 3.1.3, vehicle device 3 and control center 2 are protected against falsification, manipulation and vandalism. Each vehicle device 3 is thus unambiguously assigned to the official motor vehicle registration number of a quite specific motor vehicle which is liable for tolls.

If a vehicle with vehicle device 3 changes the official motor vehicle registration number, the holder must notify the operator company of this. In addition, the change must be carried out at a service center, i.e. stored on the collection card 3.1.3 and reported to the control center 2.

If only a new registration number is assigned while the holder remains the same, for example after the change of a location, it is sufficient to change or replace the collection card 3.1.3 and issue a corresponding message to the control center 2. This ensures that collections which are possibly not yet transmitted are transmitted in advance with the previous registration number to the control center 2.

When the holder changes, for example when the vehicle is sold, the previous holder and the new holder must reach agreement about the tolls which are incurred between the sale and reregistration.

The user can place the vehicle device 3 in the “funds receipt mode” operating state. In this case, it continues to carry out collections for checking and monitoring purposes, and transmits the collection data to the control center 2, without, however, initiating payments. This operating state which can be clearly recognized by the user is provided for special cases in which he explicitly wishes to use the funds receipt system.

On the part of the control center, the vehicle device 3 can be blocked if specific circumstances so require, for example unpaid demands, theft of the vehicle etc. This blocking is also unambiguously apparent to the user.

Correspondence between the official registration number and the registration number assigned to the vehicle device 3 of a motor vehicle which is liable for tolls is checked in the following cases:
during automatic checking, by comparing the registration number registered by the vehicle device 3 with the optoelectronically determined number,
in the case of stationary or mobile checking, by comparing the registration number registered by the vehicle device 3 with the actual registration number.

Within the framework of its possibilities, the operator company provides for a vehicle device 3 to be immediately deactivated if a deviation is detected between the actual and stored registration number.

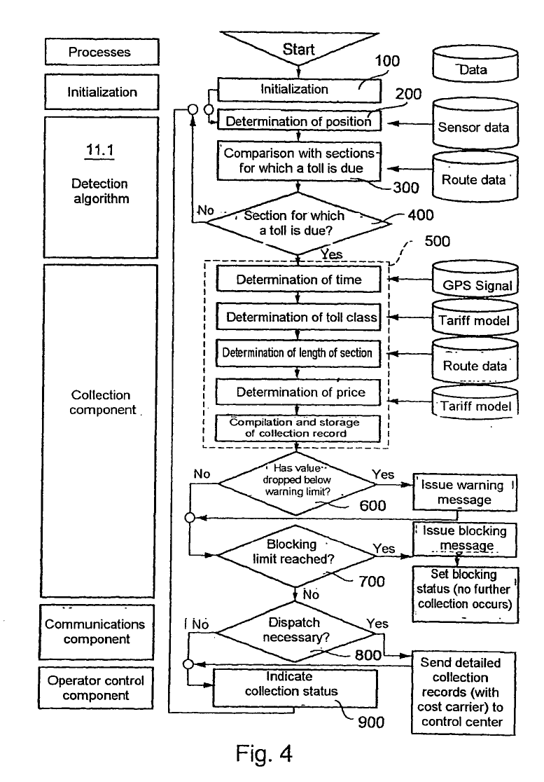

The normal operating sequence of the vehicle device is shown in FIG. 4. After the start, the vehicle device 3 is initialized in step 100. The determination of vehicle position is carried out in step 200, and the comparison with sections for which a toll is due is carried out in step 300. In step 400 it is checked whether or not there is a section of a route for which a toll is due. If this is the case, in step 500 the necessary data for the collection set is determined and stored. In step 600 it is checked whether a warning limit has been exceeded. In step 700 it is checked whether or not a blocking limit has been reached. In step 800 it is checked whether a predefined threshold value has been reached and whether it is necessary to dispatch the amount of money determined or not. In step 900 the collection status is indicated to the user 10.

Operating data contain tariff data and route data and software. By reference to the tariff data, the vehicle device 3 can calculate the toll to be paid for a detected section of route taking into account the toll class. Using the route data, the vehicle device 3 detects route sections for which a toll is due by comparison with the current position and the course of the journey (step 400).

The software permits the toll collection to be carried out in the vehicle devices 3 and is of modular design.

By means of blocking messages it is possible to block or unblock the vehicle device 3, and the process of payment of the toll can therefore be switched on or off.

The service center 9 has in each case the latest versions of operating data in order to be able to update the vehicle devices 3 on installation. For this reason, when the system is first started it is not necessary to set up a connection via the mobile radio network between the vehicle device 3 and vehicle device operations control center 2 for the downloading of operational data.

If the vehicle device operations control center 2 has received a blocking status from the vehicle device 3, such status is passed on to the “central processes” component.

By transmitting collection data which has been received in the collection data management facility to the monitoring system, it is possible to use a batch method for subsequently checking vehicle devices which are checked.

For the purposes of billing, performance data is transmitted from the automatic toll collection system 1 to the “central processes” component.

If the vehicle device 3 has received a blocking instruction or unblocking instruction, it transmits its status—blocking statuses—(blocked, not blocked, type of fault) back to the vehicle device operations control center 2.

During the cyclical checking of the vehicle device 3 in the service center 9, status information can be read out of the vehicle device 3. In this case this is information about the operating state of the vehicle device 3, about faults which have occurred and detected attempts at manipulation.

By means of collection data it is possible to try, unambiguously, all the individual collections and assign them to the official registration number of the motor vehicle which is liable for a toll. This includes the location and time of the collection, the declared toll class, the calculated toll, the vehicle device identification and possibly in addition the official registration number and cost bearer parameters for cost differentiation. The transmission of collection data is either triggered after a dispatch limit is exceeded, or after a specific time period expires. The dispatch limit is a credit balance value or credit facility value. The time period can be parameterized. It starts from the first collection since the last dispatch of collection data. If the dispatch limit has not yet been reached after this time period expires, the transmission of existing collection data is nevertheless triggered.

When checking takes place, the relevant collection data and status information is transmitted to the checking system 7. Said status information includes information on abnormal operating states and detected attempts at manipulation in the past and blocking status information.

When it is installed, the current operating data is transmitted into the vehicle device 3. This eliminates the need for a complex setup of communications with the vehicle device operations control center 2 the said vehicle device 3 is first brought into operation.

After installation has taken place, the status data is transmitted to the “central processes” component. If a vehicle device 3 leaves the service center 9 in the installed but not functionally capable state without receiving official acceptance, for urgent reasons, this status is also signaled to the “central processes” component.

When a journey is started, the user 10 enters the parameters relating to toll liability into the vehicle device 3. Variable parameters which change the toll class are the trailer parameters (number of axles and permitted overall weight). The toll-related parameters provided at that time for the motor vehicle for which a toll is due (pollutants emission class, axles present on the vehicle and permitted overall weight) do not change during use. Changes to the motor vehicle parameters require technical changes to the vehicle and a reconfiguration of the vehicle device 3 at the service center 9.

The route data and tariff data created in the “central processes” component is converted in the vehicle device operations control center 2 to a format which can be processed by the vehicle devices 3.

If a blocking event or unblocking event has been triggered for a specific vehicle device 3 in a “central processes” component, it generates an instruction and transmits it to the vehicle device operations control center 2.

When the vehicle device 3 is installed, the service center 9 must check how up to date the data of the vehicle card (which the user must submit for installation) is. Furthermore, it is possible to interrogate information which was not yet present at the time of the registration of the user 10, for example relating to checking of creditworthiness.

The supporting beacon 5 transmits monitoring data to the “central processes” component at cyclical intervals so that said component can detect the operational capability of the supporting beacon 5.

The supporting beacon 5 transmits position data to the vehicle device 3 in order to support the determination of positions.

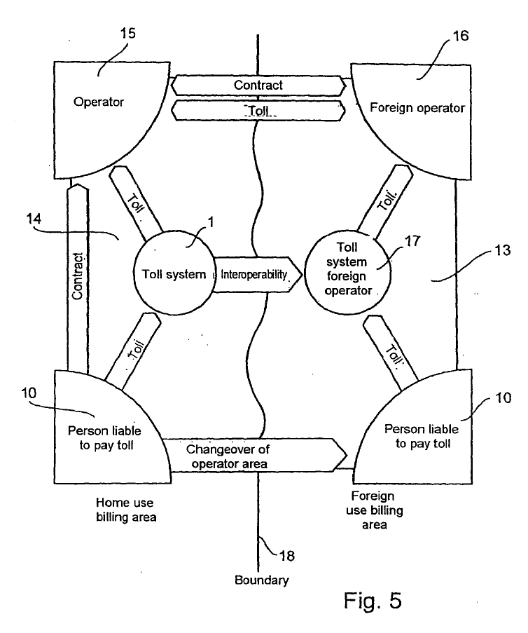

FIG. 5 shows a basic view of the interoperability between various use calculation regions 13, 14. The interoperability makes it possible for the person 10 who is liable for a toll to pay the toll with only one vehicle device 3 and possibly only one contract in various use calculation regions 13, 14 with various electronic toll systems 1, 17, it being possible for the toll systems to be operated by various operators 15, 16.

The technical interoperability is the basic precondition to be able to use a piece of vehicle equipment 3 in more than one toll system region 13, 14. The technical interoperability is defined, on the one hand, by communication between the vehicle unit 3 and the operator-specific local installations and, on the other hand, by the functions and sequences which are anticipated in the vehicle unit 3 and which the respective toll system operator 15, 16 anticipates.

In its basic equipment level, the vehicle device 3 provides the communications channels via mobile radio (GSM) in various line-oriented and packet-oriented services as well as DSRC beacon communication by infrared. An interface according to CEN TC278 by radio in the microwave band of 5.8 GHz can optionally be connected or integrated alongside. The basic function of the computer system in the vehicle device 3 provides the possibility of subsequently reloading other applications, in an appropriately protected way, using various communications channels, in addition to the software functions of the system itself which are provided on a standard basis.

In particular, the following features of the vehicle device 3 provide the preconditions for technical interoperability:
connectable DSRC interface,
use of security modules (chip cards),
multiapplication capability due to the possibility of transmitting equipment operators and applications into the vehicle devices 3 in a protected fashion via the communications channels. This occurs both before the first installation in a vehicle (so that these functions are present from the start), and subsequently if the need becomes apparent only later or if a new system is defined and introduced.
Defined internal interface between applications and the basic functions of the vehicle device 3 which makes it possible to define and carry out changes/expansions in a uniform way independently of device manufacturers.
Use of TCP/IP-PPP as a standard for the GSM bearer service in order also to be able to carry out other transactions with other control centers which also use the TCP/IP-PPP.
Use of ISO ENV 14906 EFC (application interface) in order to be able to support all the beacon-supported transactions based on CEN DSRC.

This provides the precondition for basic interoperability which makes it possible to participate in other toll systems 17 which use these modern standards only by reloading a software package (for example by means of GSM).

For other systems, the vehicle device 3 can be expanded with an additional hardware communications module. This opens up the possibility of also using other communications channels which are of interest for only a relatively small number of the vehicles, without making the basic device more expensive.

With the abovementioned expansion possibilities by means of software applications or additional hardware communications modules, the vehicle device 3 becomes technically interoperable with a wide range of systems.

The various optional communications modules are connected to the standardized internal interface and controlled by the respective operator-specific protocols. The protocols control both the collection process and payment process as well as the self-checking process.

The protocols can be loaded over a defined interface of the vehicle device 3 (multiapplication capability). The vehicle device provides for this purpose the following possibilities:
service interface (garage)
GSM
protocols are loaded by a chip card (interoperability card).

The toll systems which are currently operating utilize a chip card to secure the communications processes. The possibility of using an external chip card in the vehicle device provides a further precondition for bringing about technical interoperability. If the same chip card cannot be used in other toll areas 17 as the contractual preconditions are not yet fulfilled, the driver can still participate in the toll operation by changing the chip card.

In systems which require direct communication with the chip card by means of the collection beacon during a journey, a relatively long period in the communications area is to be ensured organizationally.

In addition to the purely technical interoperability, the preconditions must also be provided for interoperability on an organizational level. In particular payment transactions are to be considered here. European banks are already interoperable today by exchanging data carriers; i.e., money transfers from a bank in Germany to a bank of a member state of the European Community, and vice versa, are everyday transactions. For the person 10 who is liable to pay a toll to be able to pay his toll satisfactorily to another system operator 16 in a foreign use billing area 13, it is necessary, inter alia, for the demands of the bank of the other system operator 16 to be accepted by the bank of the operator company 15 in the home use billing area 14, and for the operator company 15 in the home use billing area 14 to accept the demands itself.

With pre-paid systems, the creditworthiness of the person 10 who is liable to pay a toll is inherently safeguarded, and in post-paid systems bank agreements and agreements must be agreed with the other system operators.

For all types of interoperability it is necessary for contracts to be concluded between the operator company 15 and other system operators 16. These roaming agreements make it easier for the person 10 who is liable to pay a toll as he has to conclude a contract with only one system operator.

Roaming agreements should regulate at least the following points:
expiration of the payment management
definition of notice periods
security aspects, in particular release of keys
protocols of toll systems
data for the checking processes
telecommunications to be used
infrastructure
definition of receipts data.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed:

1. A road toll collection system having a vehicle device for vehicle-autonomous determination of a road toll for a vehicle within a use billing area, wherein:
data required for determining the road toll are transmitted, when required, from an operator control center to the vehicle device by means of a communications device;
the vehicle device determines partial tolls which are incurred continuously for traveled route sections, and determines the total toll for a journey by summing the individual partial tolls;
when predefined criteria are fulfilled, the vehicle device transmits a current determined total toll, via the communications device, to the operator control center for billing;
the road toll collection system includes various use billing areas with differing electronic toll systems; and
the road toll which is due for a vehicle when different use billing areas are traveled through is determined by a single vehicle device.

2. The road toll collection system as claimed in claim 1, wherein:
the predefined criteria include,
reaching or exceeding a threshold value;
receipt of a request for data from the control center;
manual triggering of a data transmission by a vehicle user; and
the vehicle's traveling through predefined positions in the route network; and
the threshold value comprises at least one of a specific amount of money, a specific time period, and a specific distance covered since the last time when data was transmitted.

3. The road toll collection system as claimed in claim 1, wherein:
a vehicle user maintains an account with an operator of the road use system for billing; and
the transmitted tolls are automatically deducted from said account.

4. The road toll collection system as claimed in claim 1, wherein:
information about boundaries of at least one home use area is stored in the vehicle device;
when the boundary of a use area is approached, the vehicle device requests any missing operating data for an adjoining use area from the control center; and
the requested operating data is transmitted from the control center to the vehicle device via a communications device and stored in the vehicle device.

5. The road toll collection system as claimed in claim 1, wherein when a use billing area boundary between two use billing areas is passed through, an applicable road toll is determined in accordance with conditions of the new use billing area.

6. The road toll collection system as claimed in claim 2, wherein if the road toll in a new use billing area entered by the vehicle is levied by a different operator from that in the home use billing area, automatic billing is possible only if the operator of the home use billing system confirms transfer of the responsibility of the holder of the vehicle.
